(19) United States
(12) Patent Application Publication
(10) Pub. No.: US 2021/0149821 A1
(43) Pub. Date: May 20, 2021

(54) ADDRESS TRANSLATION TECHNOLOGIES

(71) Applicant: Intel Corporation, Santa Clara, CA (US)

(72) Inventors: Bo CUI, Shanghai (CN); Chris M. WOLF, Santa Clara, CA (US); Ren WANG, Portland, OR (US); Kaijie GUO, Shanghai (CN)

(21) Appl. No.: 17/133,503

(22) Filed: Dec. 23, 2020

(51) Int. Cl. G06F 12/1045; G06F 12/02; G06F 9/50

(52) U.S. Cl. CPC G06F 12/1063; G06F 9/5016; G06F 12/0238; G06F 12/1054

(57) ABSTRACT

Examples described herein relate to an apparatus comprising: at least one processor, when operational, to: perform a command to submit a work descriptor to a device, wherein: submission of the work descriptor causes an attempt to perform a substitution of an address in the work descriptor before submitting the work descriptor to the device. In some examples, the address comprises a guest virtual address (GVA) and the substitution of an address comprises replacement of the GVA with a host physical address (HPA) corresponding to the GVA. In some examples, the at least one processor is to: substitute the address in the work descriptor with an address translation of the address in the work descriptor if the address translation is available for access by a processor that performs the command.

Virtualization technologies such as virtual machines and containers allow applications or end users to utilize computing resources. Virtualization technologies provide an environment that allows processes, operating systems, applications or other software to share computing resources (e.g., processors, networking, storage, and memory) while permitting data security and separation.

Some solutions provide use of pinned memory whereby a virtual function (VF) driver copies user data (GVA) from application to a pinned physical contiguous memory buffer (e.g., guest physical address (GPA)) and sets this GPA pointer in a DMA descriptor for a packet to be transmitted. The NIC (e.g., connected via PCIe) can copy the packet from memory (e.g., dynamic random access memory (DRAM)) by providing a GPA and using host translation agent (e.g., IOMMU) to translate the GPA to HPA. After all those translations the memory access will be forwarded to memory controller. Pinned memory introduces another data copy from a packet buffer to a pinned memory. Pinned memory can depend on a kernel memory driver which requires user privilege to utilize. For cloud native scenarios, device descriptor rings are exposed in user space and managed by kernel-bypass software stack (e.g., Data Plane Development Kit (DPDK)) and can lack flexibility and scalability required by the massive cloud native applications.

### BRIEF DESCRIPTION OF THE DRAWINGS

FIG. 1 shows an example manner to process a packet.

FIG. 2A shows a system and process for modifying a descriptor of an egress packet.

FIG. 2B shows an example of descriptor processing.

FIG. 3 shows an example flow of sending a descriptor from a core to device queue.

FIG. 4 depicts an example process.

FIG. 5 depicts an example system.

FIG. 6 depicts an example environment.

### DETAILED DESCRIPTION

Virtualization technologies (e.g. Intel® Virtualization Technology for Directed I/O (VT-d)) provide hardware based virtualization solutions to run multiple operating systems (OSs) and applications in independent partitions (domains). To support multiple domains, an inbound memory access from an endpoint is attached with a targeted Process Address Space Identifier (PASID) to identify that the address embedded in requests is from a specified Guest Virtual Address (GVA) domain. Remapping hardware used by an input-output memory management unit (IOMMU) can translate this GVA to Host Physical Address (HPA) before utilization by other elements (e.g., address decoding, cache snooping, and/or forwarding to a memory controller).

As virtualization and container technologies utilize more domains, translation table size increases and translation speed affects overall speed and time to completion of data accesses (e.g., read or write from memory or storage). An translation cache on device (e.g., device translation lookaside buffer (TLB) consistent with PCI Express (PCIe) Address Translation Services Revision 1.1 (2009) (or derivatives thereof) or device translation lookaside buffers) can be used to pre-fetch address translations before issuing direct memory access (DMA) requests, to reduce time to complete an address translation and data copy. However, a significant GVA-to-HPA address translation latency is introduced if a local device TLB lookups fail.

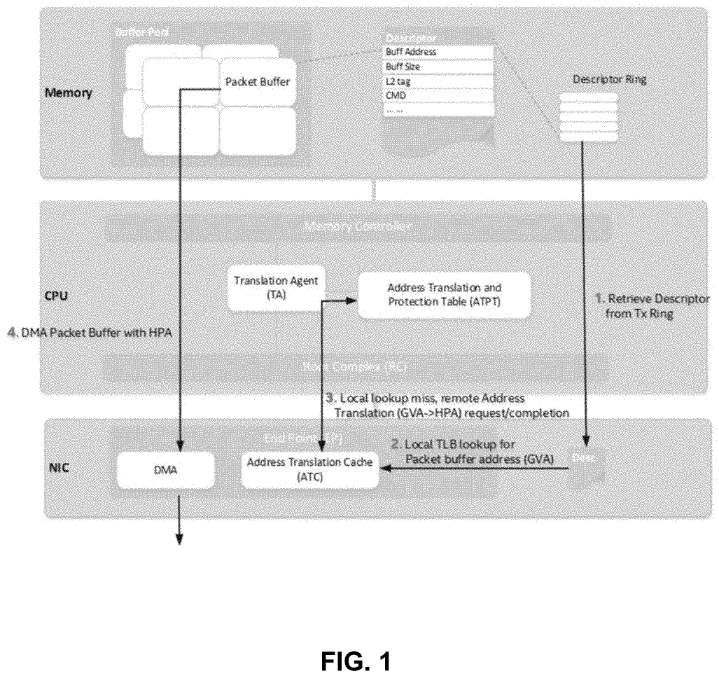

FIG. 1 shows an example manner to process a packet that is to be transmitted using a network interface controller (NIC) to a network medium. At (1), a descriptor that identifies a packet to be transmitted is provided to the NIC. The packet transmit descriptor includes a packet buffer pointer (GVA) that refers to content of a packet that is to be transmitted and at (2) the NIC performs a translation of the GVA to HPA using a TLB lookup for GVA to HPA address translation. In this example, the TLB does not include an address translation for the provided GVA and the GVA to HPA address translation by the NIC fails. At (3), remote translation is performed (e.g., page fault) to determine the GVA to HPA address translation using a call to a remote entity. At (3), the NIC requests a PCIe Address Translation Services (ATS), which introduces overhead and latency due to Address Translation Request/Completion procedure between endpoint and root complex. ATS can request root complex access if local translation fails which can increase latency of packet transmission because a translation is performed by another device and there is transaction overhead. At (4), the NIC utilizes a DMA engine to access the packet from the packet buffer associated with the translated HPA.

Various embodiments provide for address translation by a central processing unit (CPU) before a descriptor with a reference source address of a packet arrives at a NIC. Various embodiments intercept a transmit descriptor and replace a virtual address in the descriptor with a HPA buffer pointer. Various embodiments utilize a direct store instruction which can be used for atomic writing of device-hosted queues. For example, an atomic write operation from a CPU may not be interrupted until the device-hosted queue returns a result. Multiple writes (from multiple cores) can be issued simultaneously, but from device queue point of view those operations are serialized and are atomic. Using a direct store instruction, a descriptor can be copied by a driver to a PCIe end point using a CPU-initiated write to a NIC instead of a device-initiated direct memory access (DMA) read of a descriptor. For example, a direct store instruction can include Intel® Architecture ENQCMD instruction that provides 64-byte atomic writing of device-hosted queues. In some examples, the ENQCMD causes writing of at least one work descriptor to device. In some examples, the work descriptor can be 64-bytes in length. In some examples, ENQCMD is supported by Linux Kernel.

Various embodiments utilize a Device Descriptor Translation Agent (DDTA) to process descriptors for packet transmissions and replace a data buffer pointer field in the descriptor from GVA to HPA. DDTA can utilize a Device Descriptor Attribute Table (DDAT) to translate GVA to HPA. In some examples, an IOMMU can be utilized by an uncore to perform translation inside the uncore. In some examples, DDTA is part of a CPU uncore or can be an offload engine accessible to the CPU.

Various embodiments provide address substitution during or after execution of a direct store instruction to replace an address field in a descriptor before the descriptor is stored into a device queue or register of a NIC or other device. The NIC can initiate a system memory copy of a packet to be transmitted from an address specified by the converted HPA buffer pointer by setting an Address Translation (AT) field of a PCIe Transaction Layer Packets (TLP). Various embodiments can eliminate or reduce use of remote address translation and corresponding latency and reduce impact on packet transmission rates. Various embodiments can eliminate the additional address translation service (ATS) cost defined within the PCI Express Base Specification.

Various embodiments may provide address translation ahead of processing of descriptor to reduce packet transmission latency by using descriptor processing pipeline once instead of performing descriptor processing and then performing translation. Various embodiments may protect physical memory addresses from being exposed to a customer or otherwise exposed to entities that are not permitted to have knowledge of the physical memory addresses. Various embodiments may provide address translation inside a CPU and provide a root of trust inside a CPU.

Various embodiments provide lower device DMA latency to completion whereby a device can issue DMA to a HPA without translation latency. In some examples, address translation can be performed in a CPU internal ahead of descriptor enqueue. In some examples, address substitution can be performed by a CPU and initiated by device driver and/or OS. In some examples, during runtime, user space applications may not be not aware of the underlying address translation. In some examples, a translation failure can be returned before copying a descriptor to device queue to provide an earlier report than error reporting by the device.

Various embodiments of devices can be coupled to a CPU using any type of device interface including PCIe, CXL, DDR memory interfaces. See, for example, Peripheral Component Interconnect (PCI) Express Base Specification 1.0 (2002), as well as earlier versions, later versions, and variations thereof. See, for example, Compute Express Link Specification revision 2.0, version 0.7 (2019), as well as earlier versions, later versions, and variations thereof.

Although examples herein are provided with respect to a NIC, the examples can apply to any device that is to read or write to a region of host or system memory using a device interface. For example, a device can include an infrastructure processing unit (IPU), data processing unit (DPU), smartNlC, accelerator device (e.g., crypto engine), workload manager (e.g., Intel® hardware queue manager (HQM)), graphics processing unit, general purpose graphics processing unit (GPGPU)). An XPU can refer at least to an IPU, DPU, GPU, GPGPU, or other processing units (e.g., accelerator) and in some cases, a CPU. An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

While examples are described with respect to transmit descriptors, various embodiments could be applied to packet receive descriptors as well or any work descriptor.

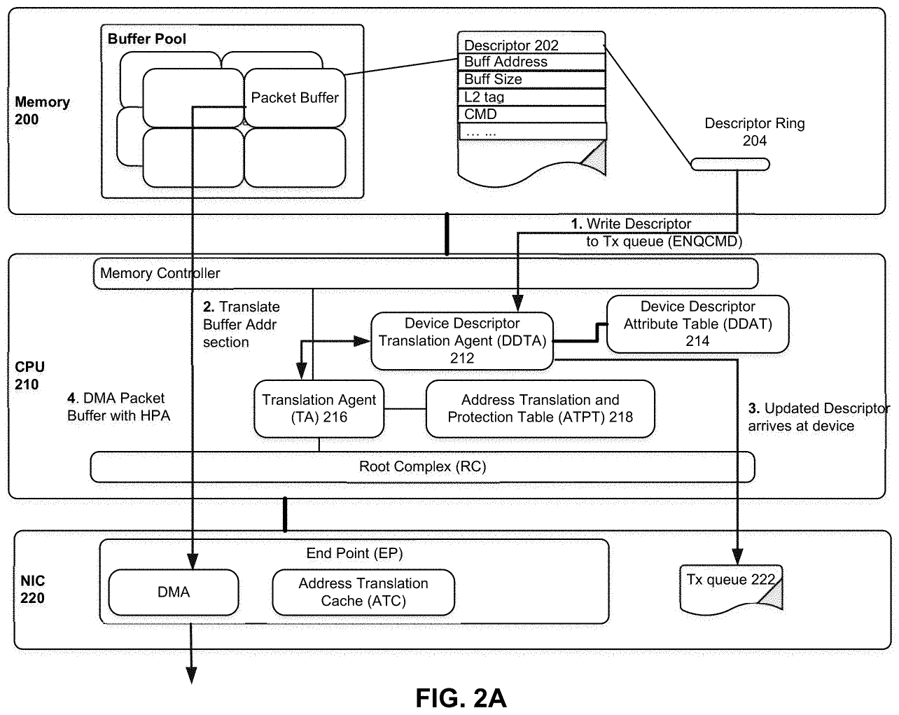

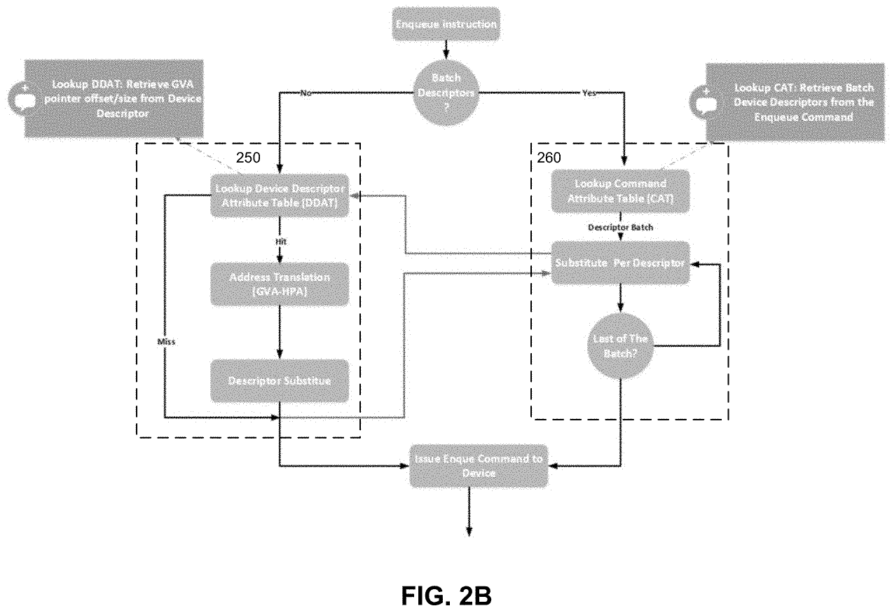

FIG. 2A shows a system and process for modifying a descriptor of an egress packet. The system can be implemented as a server, rack of servers, racks of servers, computing platform, or others. In some examples, a CPU 210 can include one or more of: a core, graphics processing unit (GPU), field programmable gate array (FPGA), or application specific integrated circuit (ASIC). In some examples, a core can be sold or designed by Intel®, ARM®, AMD®, Qualcomm®, IBM®, Texas Instruments®, among others. Cores can execute an operating system, driver, applications, and/or a virtualized execution environment (VEE) (e.g., virtual machine or container). In some examples, an operating system (OS) can be Linux®, Windows®, FreeBSD®, Android®, MacOS®, iOS®, or any other operating system. For simplicity, only two cores are shown, but more than two cores can be used.

An uncore or system agent can include or more of a memory controller, a shared cache (e.g., last level cache (LLC)), a cache coherency manager, arithmetic logic units, floating point units, core or processor interconnects, Caching/Home Agent (CHA), or bus or link controllers. A system agent can provide one or more of: direct memory access (DMA) engine connection, non-cached coherent master connection, data cache coherency between cores and arbitrates cache requests, or Advanced Microcontroller Bus Architecture (AMBA) capabilities.

For example, applications executed by any core of CPU 210 can include a service, a microservice, cloud native microservice, workload, or software. Applications can be executed in a pipelined manner whereby a core executes an application and the application provides data for processing or access by another core. According to some embodiments, an application can execute on one or multiple cores or processors and the application can allocate a block of memory that is subject to cache line demotion as described herein.

In some examples, an application can be composed of microservices, where each microservice runs in its own process and communicates using protocols (e.g., an HTTP resource API, message service, remote procedure call (RPC), or gRPC). Microservices can be independently deployed using centralized management of these services. The management system may be written in different programming languages and use different data storage technologies. A microservice can be characterized by one or more of: use of fine-grained interfaces (to independently deployable services), polyglot programming (e.g., code written in multiple languages to capture additional functionality and efficiency not available in a single language), or lightweight container or virtual machine deployment, and decentralized continuous microservice delivery.

Any application can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, a software sequence can be used to initialize the system to perform address translation of an address field before a descriptor is copied to a device (e.g., NIC 220). For example, a driver can be installed and executed by CPU 210 to initialize a device (e.g., NIC 220 or other device). An entry or multiple entries (e.g., scatter gather list (SGL)) can be added into a Command Attribute Table (CAT)/Device Descriptor Attribute Table (DDAT) 214 during device queue initialization phase. A CAT can define the layout of ENQCMD, which can vary according to device ENQCMD message format. If ENQCMD batch multiple descriptors in one message, CAT is used to retrieve each descriptor, and DDAT 214 can be used to parse and substitute internal fields of a descriptor. In some examples, one or more entries can include an address translation from GVA to HPA.

During buffer pool initialization, a memory mapping inside an IOMMU can be set in order to provide memory address translation and access by IO devices. One or more transmit request descriptor 202 can be formed and referenced by descriptor ring 204. Descriptor 202 can be formed with buffer pointer (e.g., GVA) and other fields such as buffer size, layer 2 tag, command (CMD). A default address translated (AT) flag (e.g., 1 bit or multiple bits)) in a descriptor can be set to a value to indicate address translation can be applied using embodiments described herein. A network device descriptor format can include at least: transmit packet buffer address, buffer size, AT flag, layer 2 (L2) tag (e.g., IEEE 802.3q), command (e.g., TSCP Segmentation Offload).

At (1), device driver executes on CPU 210 and writes transmit descriptors to Tx queue 222 in NIC 220. In some examples, a driver can perform enqueue command (e.g., ENQCMD) to write a descriptor to Tx queue 222 of NIC 220. Execution of the enqueue command can invoke use of DDTA 212, at (2), to perform address translation of an address in a Tx descriptor. DDTA 212 can retrieve an address translation from DDAT 214. In some examples, DDAT 214 can be stored inside a CPU's memory (e.g., SRAM or DRAM) and is only accessible or visible to CPU 210 or privileged software (e.g., hypervisor) and not to a user's application.

In some examples, the descriptor can be embedded inside an enqueue command (e.g., within a parameter that can store a descriptor) and a single enqueue command can be issued to device 220. In some examples, a descriptor array pointer can be embedded inside the enqueue command and a batch of descriptors located in another DRAM buffer can be issued to device 220.

If a translation is not available in DDAT 214 (e.g., page table miss), DDTA 212 can utilize a translation agent (TA) 216 and translation agent protection table (ATPT) 218 to perform virtual to physical address translation. DDAT 214 can request TA 216 to perform address translation of GVA to HPA (e.g., page table mapping). An address translation failure can trigger TA 216 to perform a host side address translation look up. For example, ATPT 218 can be stored in a CPU's SRAM and DRAM and is only accessible or visible to the CPU or privileged software (e.g., hypervisor) and not to a user application. In some examples, DDTA 212 can be implemented as microcode or hardware pipeline in CPU 210. In some examples, a hypervisor or other trusted system configuration entity or administrator configures address translations inside DDAT 214 and ATPT 218. For example implementations of TA and ATPT, see PCI Express (PCIe) Address Translation Services Revision 1.1 (2009). Accordingly, in some examples, the translation is finished locally inside CPU with no transaction overhead between an end point (e.g., NIC) and root complex. Various examples can perform address translation in a memory controller, direct memory access (DMA) engine, system on chip with a CPU or XPU, IOMMU.

At (3), if a translation is available, the updated descriptor can be provided to device 220. Examples described herein describe manners of handling unsuccessful address translations. At (4), device 222 can copy data (e.g., packet data) from a packet buffer identified using a descriptor. For example, a DMA engine can be used to copy the data to the endpoint device 220 (NIC).

FIG. 2B shows an example of descriptor(s) processing to substitute GVA pointer with a HPA pointer before the descriptor are issued out from the CPU uncore to a device. In branch 250, address translation is handled per descriptor. In branch 260, address translation is attempted on a batch of descriptors of descriptors and address translation is attempted to be performed on for each descriptor in the batch.

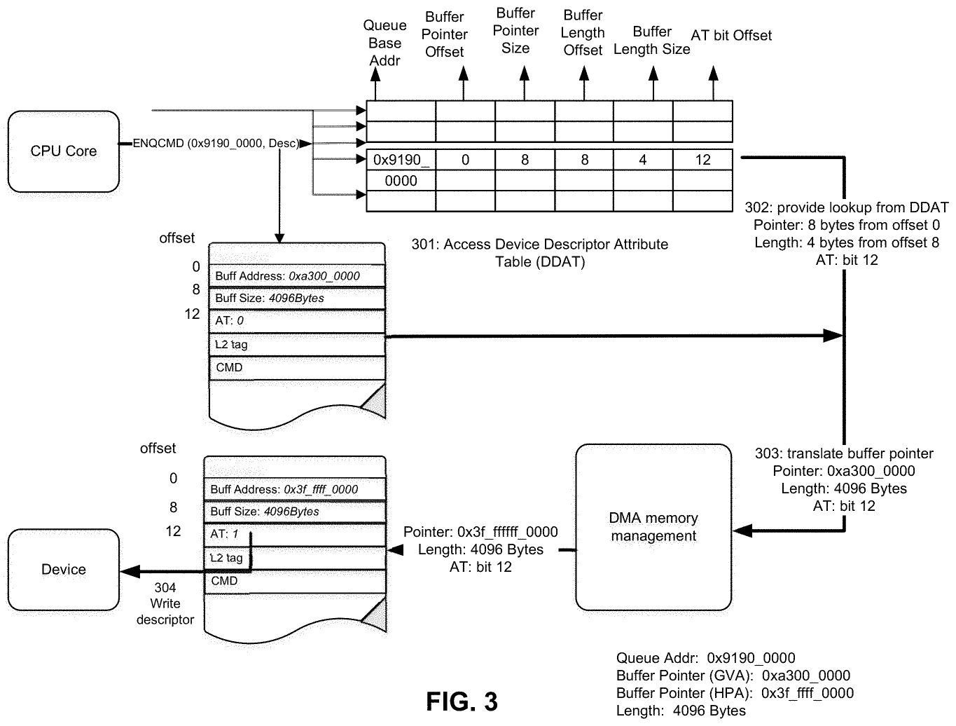

FIG. 3 shows an example flow of sending a single descriptor from CPU core to NIC device queue. For example, for a descriptor write, the CPU can perform various actions. At 301, a DDAT can be accessed for the target queue to obtain a location of DMA data buffer pointer (address) and length (size). To support Scatter-Gather List (SGL) including multiple buffers inside one descriptor, multiple entries should be added in DDAT to identify all buffer pointer/size, and subsequent translations will be applied to all buffer pointers. A miss can indicate a translation is not required for this device writing (descriptor).

At 302, an attached descriptor can be parsed with returned offsets from DDAT and the buffer pointer and length can be retrieved. At 303, a buffer pointer can be translated from GVA to HPA by DMA memory management. A successful translation can indicate a buffer is stored in contiguous HPA buffer with specified size. A failed translation can indicate GVA is an invalid address and the descriptor is not sent to a device queue and execution of instruction enqueue can return an error directly to the driver. If a translation succeeds, the descriptor is modified with a substitute address field of HPA pointer (in place of GVA pointer) and Address Translated (AT) is set to indicate an address translation was performed inside the descriptor (e.g., AT=1). If translation is invalid, the descriptor can be sent to device (e.g., AT=0) and the device can perform standard translation using remote translation service. A translation can be marked as invalid if a GVA buffer is not mapped to contiguous HPA. At 304, the descriptor can be sent to a device queue. The device can access data or content from a buffer identified by an address in the descriptor, after translation of the address.

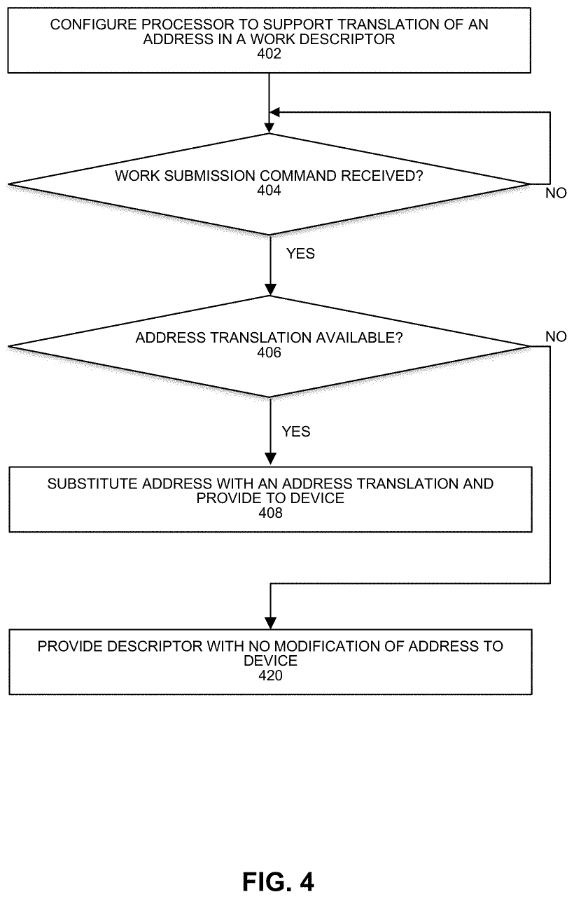

FIG. 4 depicts an example process. At 402, a processor can be configured to support address translation in connection with performance of an work submission command. For example, the work submission command can cause submission of a work descriptor to a device where the work descriptor refers to a job for the device to perform. Various examples of devices are described herein. At 404, in response to a request to execute a work submission command, the process can proceed to 406. At 406, a determination is made if an address translation can be performed. The address translation can be between a guest virtual address (GVA) to a host physical address (HPA). If an address translation is present in a memory of a processor that performs the work submission command, the process can proceed to 408. If an address translation is not present in the processor's memory, the process can proceed to 420. At 408, an address translation can be performed. For example, a GVA address in the work descriptor can be substituted with its translated HPA. In some examples, the descriptor can be updated to indicate a substitute address is provided. At 408, the descriptor with its substitute address and indication of a substitute address can be provided to the device. Thereafter, the device can access data referenced by the descriptor from the HPA.

At 420, the descriptor with an unmodified address can be provided to the device. In some examples, the descriptor can be updated to indicate no substitute address was provided. The device can request an address translation of a GVA to HPA. Thereafter, the device can access data referenced by the descriptor from the HPA.

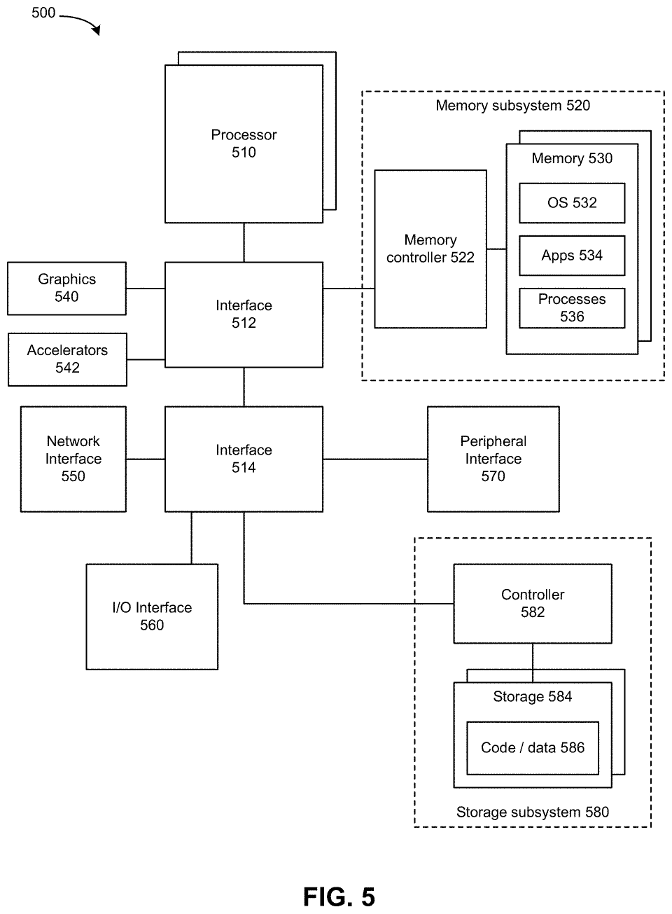

FIG. 5 depicts an example system. The system can use embodiments described herein to provide address translation in a work descriptor in connection with a work submission to a device. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that uses higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be fixed function and/or programmable offload engines that can be accessed or used by a processor 510. For example, an accelerator among accelerators 542 can provide compression (DC) capability, cryptography services such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It can be understood that memory controller 522 could be a physical part of processor 510 or a physical part of interface 512. For example, memory controller 522 can be an integrated memory controller, integrated onto a circuit with processor 510.

While not specifically illustrated, it can be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. Various embodiments can be used in connection with network interface 550, processor 510, and memory subsystem 520.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 500. More specifically, power source typically interfaces to one or multiple power supplies in system 500 to provide power to the components of system 500. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), Infinity Fabric (IF), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

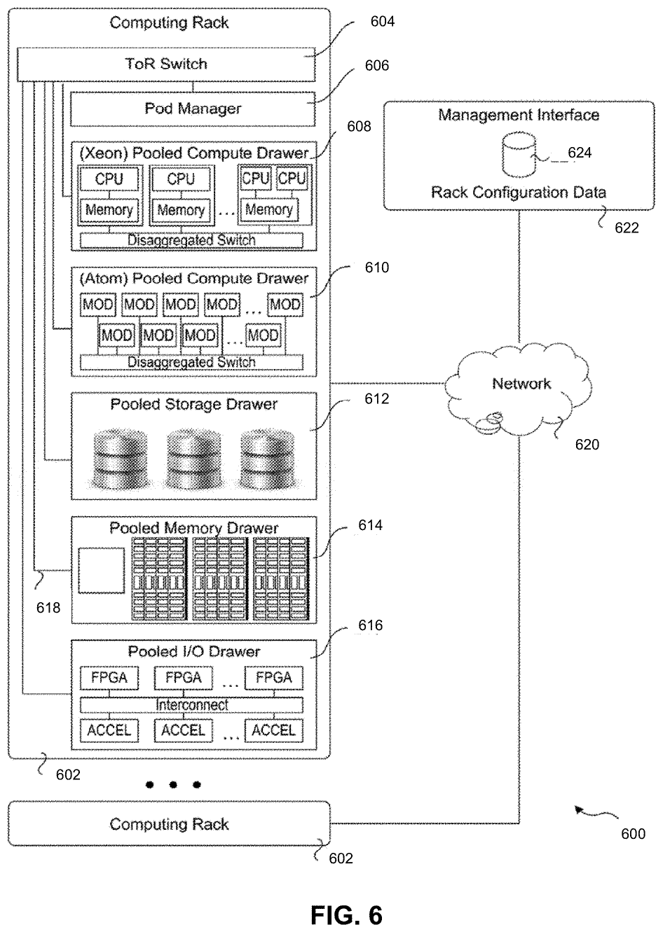

FIG. 6 depicts an environment 600 includes multiple computing racks 602, one or more including a Top of Rack (ToR) switch 604, a pod manager 606, and a plurality of pooled system drawers. Various embodiments can be used among racks to provide address translation in a work descriptor in connection with a work submission to a device. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® XEON® pooled computer drawer 608, and Intel® ATOM™ pooled compute drawer 610, a pooled storage drawer 612, a pooled memory drawer 614, and a pooled I/O drawer 616. Any of the pooled system drawers is connected to ToR switch 604 via a high-speed link 618, such as a 40 Gigabit/second (Gb/s) or 100 Gb/s Ethernet link or a 100+Gb/s Silicon Photonics (SiPh) optical link, or higher speeds.

Multiple of the computing racks 602 may be interconnected via their ToR switches 604 (e.g., to a pod-level switch or data center switch), as illustrated by connections to a network 620. In some embodiments, groups of computing racks 602 are managed as separate pods via pod manager(s) 606. In one embodiment, a single pod manager is used to manage all of the racks in the pod. Alternatively, distributed pod managers may be used for pod management operations.

Environment 600 further includes a management interface 622 that is used to manage various aspects of the environment. This includes managing rack configuration, with corresponding parameters stored as rack configuration data 624.

In some examples, embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

For example, various embodiments can be used for wired or wireless protocols (e.g., 3GPP Long Term Evolution (LTE) (4G) or 3GPP 5G), on-premises data centers, off-premises data centers, base station devices, sensor data sender or receiver devices (e.g., for autonomous vehicles or augmented reality applications), endpoint devices, servers, routers, edge network elements (computing elements provided physically closer to a base station or network access point than a data center), fog network elements (computing elements provided physically closer to a base station or network access point than a data center but further from an edge network), and/or hybrid data centers (e.g., data center that use virtualization, cloud and software-defined networking to deliver application workloads across physical data centers and distributed multi-cloud environments). Network or computing elements can be used in local area network (LAN), metropolitan area network (MAN), network with devices connected using optical fiber links, campus area network (CAN), or wide area network (WAN).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes a method comprising: receiving a command to copy a descriptor to a device and modifying performance of the command by performing a substitution of an address in the descriptor and providing the descriptor, with the substitution address, to the device.

Example 2 includes any example, wherein the address comprises a guest virtual address (GVA) and the substituted address comprises a host physical address (HPA) that is a translation of the GVA.

Example 3 includes any example, and includes: determining if an address translation of the address in the descriptor is available for access by a processor that executed the command, wherein: modifying performance of the command by performing a substitution of an address in the descriptor and providing the descriptor, with the substituted address, to the device comprises performing a substitution of the address in the descriptor based on the address translation of the address in the descriptor being available for access by the processor.

Example 4 includes any example, and includes: based on the address translation of the address in the descriptor not being available for access by the processor, providing the descriptor, without substitution of the address in the descriptor, to the device.

Example 5 includes any example, wherein the command causes writing of at least one work descriptor to the device.

Example 6 includes any example, wherein the command comprises ENQCMD.

Example 7 includes any example, wherein the device comprises one or more of: network interface controller, accelerator, infrastructure processing unit (IPU), data processing unit (DPU), smartNlC, accelerator device, workload manager, graphics processing unit, general purpose graphics processing unit (GPGPU).

Example 8 includes any example, wherein the descriptor includes an indicator of whether an address substitution was performed and one or more of: an address, length of data, and packet-related information.

Example 9 includes any example, and includes a computer-readable medium, comprising instructions stored thereon, that if executed by at least one processor, cause the at least one processor to: perform a command to submit a work descriptor to a device, wherein: submission of the work descriptor causes an attempt to perform a substitution of an address in the work descriptor before submitting the work descriptor to the device.

Example 10 includes any example, wherein the address comprises a guest virtual address (GVA) and the substitution of an address comprises replacement of the GVA with a host physical address (HPA) corresponding to the GVA.

Example 11 includes any example, and includes instructions stored thereon, that if executed by at least one processor, cause the at least one processor to: substitute the address in the work descriptor with an address translation of the address in the work descriptor if the address translation is available for access by a processor that performs the command.

Example 12 includes any example, and includes instructions stored thereon, that if executed by at least one processor, cause the at least one processor to: submit the work descriptor, without substitution of the address in the descriptor, to the device based on an address translation of the address in the work descriptor not being available for access by a processor that performs the command.

Example 13 includes any example, wherein the command comprises ENQCMD.

Example 14 includes any example, wherein the device comprises one or more of: network interface controller, accelerator, infrastructure processing unit (IPU), data processing unit (DPU), smartNlC, accelerator device, workload manager, graphics processing unit, general purpose graphics processing unit (GPGPU).

Example 15 includes any example, wherein the work descriptor includes an indicator of whether an address substitution was performed and one or more of: an address, length of data, and packet-related information.

Example 16 includes any example, and includes an apparatus comprising: at least one processor, when operational, to: perform a command to submit a work descriptor to a device, wherein: submission of the work descriptor causes an attempt to perform a substitution of an address in the work descriptor before submitting the work descriptor to the device.

Example 17 includes any example, wherein the address comprises a guest virtual address (GVA) and the substitution of an address comprises replacement of the GVA with a host physical address (HPA) corresponding to the GVA.

Example 18 includes any example, wherein the at least one processor is to: substitute the address in the work descriptor with an address translation of the address in the work descriptor if the address translation is available for access by a processor that performs the command.

Example 19 includes any example, wherein the at least one processor is to: submit the work descriptor, without substitution of the address in the descriptor, to the device based on an address translation of the address in the work descriptor not being available for access by a processor that performs the command.

Example 20 includes any example, and includes the device communicatively coupled to the at least one processor, wherein the device comprises one or more of: network interface controller, accelerator, infrastructure processing unit (IPU), data processing unit (DPU), smartNlC, accelerator device, workload manager, graphics processing unit, general purpose graphics processing unit (GPGPU).

Example 21 includes any example, and includes a server, rack of servers, or a datacenter, wherein one or more of the server, rack of servers, or a datacenter are to execute an application or microservice that causes performance of the command.

What is claimed is:

1. A method comprising:
receiving a command to copy a descriptor to a device and
modifying performance of the command by performing a substitution of an address in the descriptor and providing the descriptor, with the substitution address, to the device.

2. The method of claim 1, wherein the address comprises a guest virtual address (GVA) and the substituted address comprises a host physical address (HPA) that is a translation of the GVA.

3. The method of claim 1, comprising:
determining if an address translation of the address in the descriptor is available for access by a processor that executed the command, wherein:
modifying performance of the command by performing a substitution of an address in the descriptor and providing the descriptor, with the substituted address, to the device comprises performing a substitution of the address in the descriptor based on the address translation of the address in the descriptor being available for access by the processor.

4. The method of claim 3, comprising:
based on the address translation of the address in the descriptor not being available for access by the processor, providing the descriptor, without substitution of the address in the descriptor, to the device.

5. The method of claim 1, wherein the command causes writing of at least one work descriptor to the device.

6. The method of claim 1, wherein the command comprises ENQCMD.

7. The method of claim 1, wherein the device comprises one or more of: network interface controller, accelerator, infrastructure processing unit (IPU), data processing unit (DPU), smartNlC, accelerator device, workload manager, graphics processing unit, general purpose graphics processing unit (GPGPU).

8. The method of claim 1, wherein the descriptor includes an indicator of whether an address substitution was performed and one or more of: an address, length of data, and packet-related information.

9. A computer-readable medium, comprising instructions stored thereon, that if executed by at least one processor, cause the at least one processor to:
perform a command to submit a work descriptor to a device, wherein:
submission of the work descriptor causes an attempt to perform a substitution of an address in the work descriptor before submitting the work descriptor to the device.

10. The computer-readable medium of claim 9, wherein the address comprises a guest virtual address (GVA) and the substitution of an address comprises replacement of the GVA with a host physical address (HPA) corresponding to the GVA.

11. The computer-readable medium of claim 9, comprising instructions stored thereon, that if executed by at least one processor, cause the at least one processor to:
substitute the address in the work descriptor with an address translation of the address in the work descriptor if the address translation is available for access by a processor that performs the command.

12. The computer-readable medium of claim 9, comprising instructions stored thereon, that if executed by at least one processor, cause the at least one processor to:
submit the work descriptor, without substitution of the address in the descriptor, to the device based on an address translation of the address in the work descriptor not being available for access by a processor that performs the command.

13. The computer-readable medium of claim 9, wherein the command comprises ENQCMD.

14. The computer-readable medium of claim 9, wherein the device comprises one or more of: network interface controller, accelerator, infrastructure processing unit (IPU), data processing unit (DPU), smartNlC, accelerator device, workload manager, graphics processing unit, general purpose graphics processing unit (GPGPU).

15. The computer-readable medium of claim 9, wherein the work descriptor includes an indicator of whether an address substitution was performed and one or more of: an address, length of data, and packet-related information.

16. An apparatus comprising:
at least one processor, when operational, to:
perform a command to submit a work descriptor to a device, wherein:
submission of the work descriptor causes an attempt to perform a substitution of an address in the work descriptor before submitting the work descriptor to the device.

17. The apparatus of claim 16, wherein the address comprises a guest virtual address (GVA) and the substitution of an address comprises replacement of the GVA with a host physical address (HPA) corresponding to the GVA.

18. The apparatus of claim 16, wherein the at least one processor is to:
substitute the address in the work descriptor with an address translation of the address in the work descriptor if the address translation is available for access by a processor that performs the command.

19. The apparatus of claim 16, wherein the at least one processor is to:
submit the work descriptor, without substitution of the address in the descriptor, to the device based on an address translation of the address in the work descriptor not being available for access by a processor that performs the command.

20. The apparatus of claim 16, comprising the device communicatively coupled to the at least one processor, wherein the device comprises one or more of: network interface controller, accelerator, infrastructure processing unit (IPU), data processing unit (DPU), smartNlC, accelerator device, workload manager, graphics processing unit, general purpose graphics processing unit (GPGPU).

21. The apparatus of claim 16, comprising a server, rack of servers, or a datacenter, wherein one or more of the server, rack of servers, or a datacenter are to execute an application or microservice that causes performance of the command.
